(19) United States
(12) Patent Application Publication
(10) Pub. No.: US 2026/0063488 A1
(43) Pub. Date: Mar. 5, 2026

(54) TRIBO-INDUCED CHARGES BASED TENSION SENSING CABLES FOR CABLE-DRIVEN MECHANISMS

(71) Applicant: The Chinese University of Hong Kong, Hong Kong (CN)

(72) Inventors: Kai Yu TONG, Hong Kong (CN); Disheng XIE, Hong Kong (CN); Yunlong ZI, Hong Kong (CN); Haoyu WANG, Hong Kong (CN); Shuk Fan TONG, Hong Kong (CN); Yujie SU, Hong Kong (CN)

(21) Appl. No.: 19/314,419

(22) Filed: Aug. 29, 2025

Related U.S. Application Data
(60) Provisional application No. 63/689,082, filed on Aug. 30, 2024.

(51) Int. Cl. G01L 5/10; G01L 1/00

(52) U.S. Cl. CPC G01L 5/10; G01L 1/005

(57) ABSTRACT

Tensions sensing cables for cable driven mechanisms for robotics, particularly surgical robotics, are provided. The tension sensing cables are configured to respond to axial tensile force applied onto the cable, where the radial pressure applied onto the cable has a lower effect on a voltage output of the cable compared to the axial force. The cable includes a primary conductive filament and a secondary conductive filament, where the primary and/or secondary filaments are wound in a helical fashion and configured such that when the primary and secondary filaments contact with each other, charges transfer between the primary filament and secondary filament on both contacted surfaces. When an axial tensile force is applied to the cable, a potential difference generated by the transferred charges between the primary and secondary filaments changes, wherein the change corresponds to the applied axial tensile force.

### CROSS-REFERENCE TO RELATED APPLICATION

The present application claims the benefit of U.S. provisional application Ser. No. 63/689,082, filed Aug. 30, 2024, which is hereby incorporated by reference herein in its entirety, including any figures, tables, or drawings.

### FIELD OF THE INVENTION

The invention pertains to tension sensing cables for cable-driven mechanisms, particularly for surgical robotics.

### BACKGROUND OF THE INVENTION

The rise of soft robotics and applications like cable driven-surgical robot have introduced challenges in regard to force measurements. The conventional strain gauge approach affects output performance and is impractical in constrained environments. Fragile measurements like Bragg gratings also face challenges in complex interactive settings. Emerging technologies, like artificial muscles, further emphasize the need for more innovative measurement methods. While various technologies have been proposed there remains a need for improved, more reliable approaches by which force, particularly axial force, can be measured.

### BRIEF SUMMARY OF THE INVENTION

In one aspect, the invention pertains to a tension sensing cable that utilizes tribo-induced charges to detect tension applied to the cable itself. In some embodiments, the cable comprises a core filament and one or more additional filaments that are helically wound on the core filament. In some embodiments, the cable includes a core filament and one helically wound filament. In other embodiments, the cable includes a core filament and two additional filaments twisted closely next to each other in the same direction. The sensing mechanism relies on the accumulation of charge at multiple twists around the core yam, which amplifies the voltage output of the cable. Notably, the cable demonstrates a linear correlation and low hysteresis between the applied tension and the output voltage. This versatile cable can be employed in a wide range of applications using cable-driven methods that requires precise tension sensing capabilities, including robotics, particularly surgical robotics, or any cable-driven application.

In another aspect, the tension sensing cables respond to axial tensile force applied on the cable, where the radial pressure applied on the cable has a lower effect on a voltage output of the cable compared to the axial force. In some embodiments, the tension sensing cables include a primary conductive filament, and a secondary conductive filament, where one or both of the first and secondary filaments are wound in a helical fashion. The cable can be configured such that when the primary and secondary filaments contact with each other, charges transfer between the primary filament and secondary filament on both contacted surfaces, and when an axial tensile force is applied to the cable, a potential difference generated by the transferred charges between the primary and secondary filaments changes, wherein the change corresponds to the applied axial tensile force. In some embodiments, the tension sensing cable is configured such that bending of the cable has a lower effect on the output as compared to the axial force.

In some embodiments, the primary filament has a dielectric layer wrapped or coated thereon. In some embodiments, the secondary filament has a dielectric layer wrapped or coated thereon. In some embodiments, the primary and secondary filaments have different triboelectric series, thereby causing charges transferred between primary filament and secondary filament on both contacted surfaces. In some embodiments, the primary filament is a core filament about which the secondary filament is helically wound. In some embodiments, the secondary filament is a core filament about which the primary filament is helically wound. In some embodiments, the cable includes a dielectric core filament about which the primary and secondary filaments are helically wound in the same direction.

In some embodiments, the tension sensing cable is configured such that an overall strain of the cable when axial tensile force exerted on the cable is within 5-20%, typically 10%. In some embodiments, the cable is configured such that changes of the voltage output as the tensile axial force is exerted on the cable is quasi-linear. In some embodiments, the cable is configured such a pitch of the helically wound primary and/or secondary filament is selected to achieve a desired sensitivity. In some embodiments, the cable is configured such that the cable includes a core filament around which primary and/or secondary filaments are wound, and an elastic modulus of the core is selected to achieve a desired testing range and/or sensitivity.

Methods of fabricating tension sensing cables are also described herein.

### BRIEF DESCRIPTION OF THE DRAWINGS

The accompanying drawings, which are incorporated herein and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and can or cannot represent actual or preferred values or dimensions.

FIGS. 1A-1F are schematic diagrams of the tension sensing cable, in accordance with some embodiments.

FIG. 2 is a modelling method and process of the filament, in accordance with some embodiments.

FIG. 3 illustrates the mass-production method using a filament twisting machine, in accordance with some embodiments.

FIGS. 4A-4I show characterization results of tribo-induced charges-based tension sensing cables (TCTSCs), in accordance with some embodiments.

FIG. 5 shows a setup and data for testing output voltage of the tension sensing filament and the force exerted on the filament, in accordance with some embodiments.

FIGS. 6A-6H show the comparison between the hysteresis of force-output and force-strain, in accordance with some embodiments.

FIG. 7 shows the setup for testing frequency response and lifetime of TCTSC, in accordance with some embodiments.

FIG. 8A shows a schematic representation of the setup and FIGS. 8B-8E show test data of a response to lateral compression, in accordance with some embodiments.

FIG. 9A shows a schematic representation of the pulley mechanism and FIG. 9B shows test data of the effect of the pulley on the output of TCTSC, in accordance with some embodiments.

FIGS. 10A-10B show schematics of the existing da Vinci surgical system in accordance with prior art; FIGS. 10C-10E show schematics of the master-slave surgical robot, and FIGS. 10F-10G show test data of the master-slave surgical robot, in accordance with some embodiments.

FIGS. 11A-11C shows schematics of the EndoWrist part replacing one cable with TCTSC, in accordance with some embodiments.

FIG. 12 shows a schematic representation of the TCTSC applied onto the cable-driven prosthetic finger, in accordance with some embodiments.

FIG. 13 shows a schematic representation of the TCTSC applied onto the cable-driven elbow exosuit, in accordance with some embodiments.

FIG. 14 shows a schematic representation of the TCTSC applied onto the cable-driven parallel robot, in accordance with some embodiments.

### DETAILED DISCLOSURE OF THE INVENTION

In recent decades, the rise of soft robotics and applications, including cable driven-surgical robot, have made marked advancements in the art, yet have introduced considerable challenges in regard to force measurement. The conventional strain gauge approach to measuring force can adversely affect output performance and is impractical in constrained environments.

Fragile measurement approaches, such as Bragg gratings, also face challenges in complex interactive settings. In recent years, emerging technologies, such as artificial muscles, further emphasize the need for innovative, improved measurement methods that allows for accurate force measurements that do not adversely affect output and can be implemented in constrained and complex environments, particularly in surgical robotics and biomechanics.

### 1. Overview

In one approach to address these challenges, aspects of human biology and biomimetic materials can be utilized. For example, Golgi tendon organs in the human body, located at the muscle—tendon junction, provide a mechanism for measuring the output force of skeletal muscles—the embedded proprioceptor axons discharge when there is muscle/tendon tension, enabling direct force measurements. According to the embodiments of the subject invention, in a robotic mechanism, tribo-induced charges-based tension sensing cables (TCTSCs) can be utilized in a similar manner.

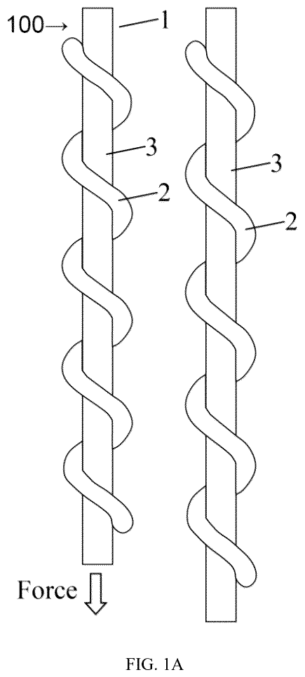

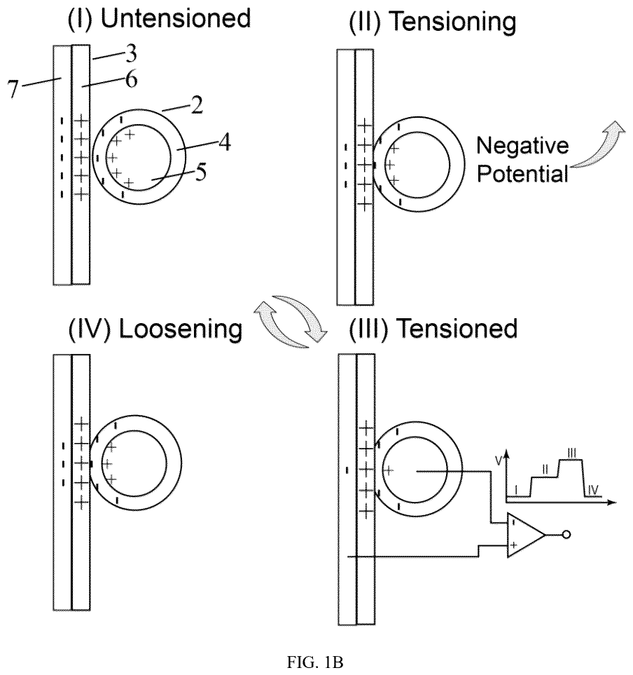

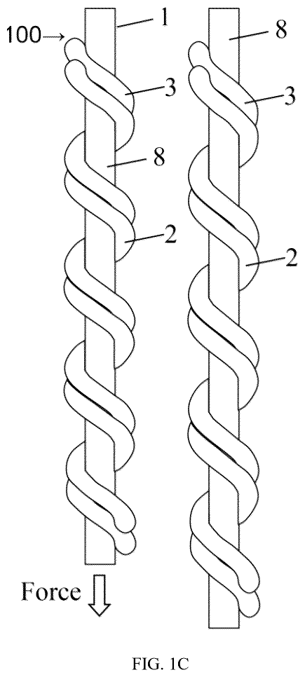

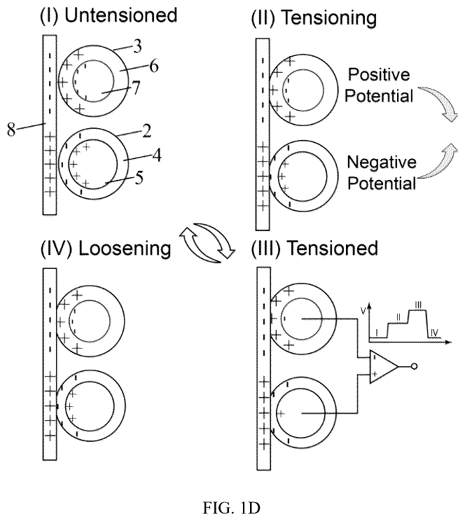

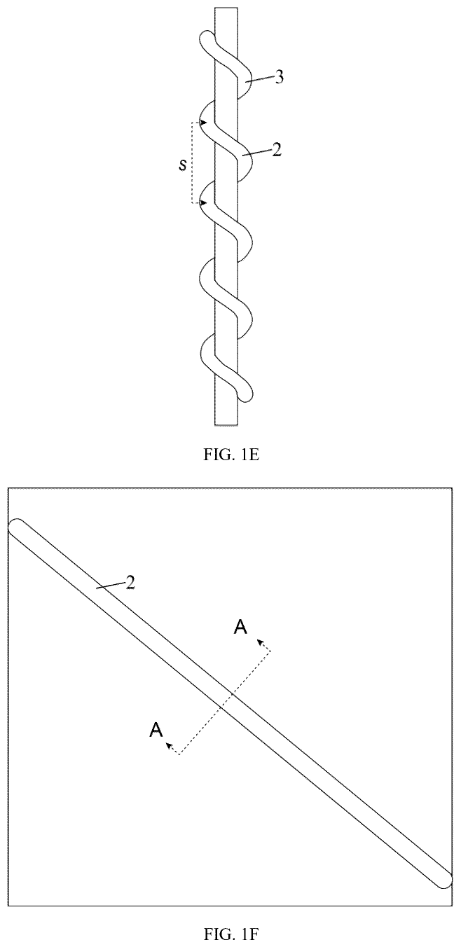

FIG. 1A shows an example of TCTSCs 100, which comprises two filaments—a positive electrode filament 2 and a negative electrode filament 3 (which also acts as core fiber 1)—with different dielectric coatings, forming a two-filament configuration. The TCTSC operates based on the triboelectric effects and electrostatic induction. When the filaments come into contact, charge transfer occurs—the positive filament loses electrons on its surface, while the negative filament gains them. It is appreciated that this configuration can include two or more filaments, such as two or more filaments wound about a central core. By these configurations described herein, the TCTSC responds to axial tensile force applied on the cable, where the radial pressure applied onto the cable has a lower effect on the output of the cable compared to the axial force.

FIG. 1B shows differing states of the TCTSC which include the resting or untensioned (I), tensioning (II), tensioned (III) and loosening (IV). In the resting state (Untensioned I), the contact area between the filaments is minimal, resulting in the largest potential difference. As shown in FIG. 1B, the TCTSC includes a dielectric layer 4 of the positive electrode filament 2, a conductor 5 of the positive electrode filament 2, a dielectric layer 6 of the negative electrode filament 3 and a conductor 7 of the negative electrode filament 3. When a tensile force is applied (Tensioning II), the helical negative filament's center diameter 5 decreases, increasing the contact area between the filaments. This reduces the distance between the positive and negative charges to the atomic level, and the overall tribo-charge density on the overlapped surface approaches zero. Only the tribo-charges on the non-contact area now induce charges on the inner electrode, decreasing the potential difference. Additional tension (Tensioned III) further increases the contact area, reducing the potential difference further. Upon unloading (Loosening IV), the TCTSC 100 returns to its original state, and the potential difference is restored. By measuring the voltage output, the TCTSC 100 provides information about the applied force magnitude. In some embodiments, the voltage output of the TCTSC can be measured by a circuit setup, as shown in Tensioned State III in FIG. 1B, although variations could be realized. The small diameter of the fibers and weak output of each winding are overcome by the exponential amplification from the accumulated charges across hundreds of windings, resulting in a noticeable voltage output at small force.

FIGS. 1C-1D show another embodiment TCTSC 100 in which the TCTSC includes three filaments, two fibers 2 and 3 helically wound about a longitudinal central core 1 defined as a pure dielectric fiber 8. These fibers perform similarly in the differing states as described in FIGS. 1A-1B, except that by measuring the voltage output of two fibers, additional resolution can be attained. In some embodiments, the voltage output of the TCTSC can be measured by a circuit setup, such as that shown in Tensioned State III in FIG. 1D, although variations could be realized.

In addition to the two-filament configuration, a three-filament configuration is introduced for different sensing ranges and sensitivities in various scenarios, such as that the embodiment shown in FIG. 1C. The positive filament 3 is moved to the outer layer, with the core filament 1 being a pure dielectric 8 for easy lectotype. Triboelectrification now occurs between the dielectric 8 and the positive filaments 3, as well as between the core 8 and the negative filaments 2. By substituting the core material, the desired range and sensitivity can be achieved for specific applications. Four configurations are mainly provided: two two-filament configurations (PTFE-Silver and PTFE-PVC) and two three-filament configurations (PTFE-0.4 Nylon-Silver and PTFE-1.0 Nylon-Silver), where the names represent the electrode materials and the diameter used. Unless explicitly stated otherwise, the data presented is from the PTFE-0.4 Nylon-Silver configuration. These fibers perform similarly in the differing states as described in FIGS. 1A-1B, except that by measuring the voltage output of two fibers, additional resolution can be attained.

In some embodiments, the voltage output of the TCTSC can be measured by a circuit setup, such as that shown in Tensioned State III in FIG. 1D, although variations could be realized.

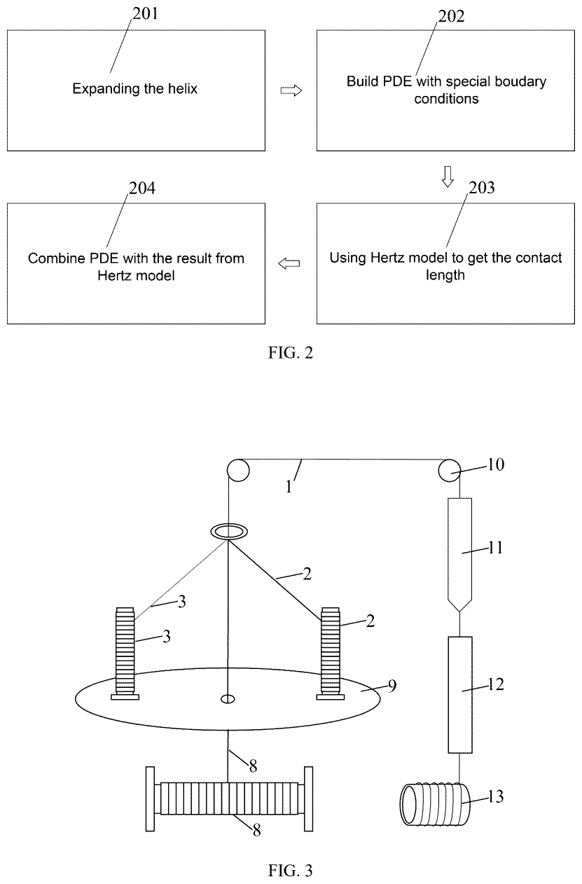

FIG. 2 shows a model that explains the cumulative effects as follows: step 201 entails expanding the helix. In some embodiments, this step converts the helix-straight filaments problem into the straight filament-plane problem by expanding the helix filament into straight filament and the core filament into a plane; step 202 entails building a partial differential equation (PDE) with special boundary conditions. In some embodiments, this is accomplished by taking any cross-section of the expansion result and establishing a one-dimensional partial differential equation pointing from the center of the cross-sectional circle to the plane through special boundary conditions. Step 203 entails using a Hertz model to determine the contact length. In some embodiments, this is accomplished by starting from the Hertz contact model of the helix and core filaments and obtaining the relationship between the unfolded straight filament and the plane, as well as the indentation relationship between the straight filament and the plane. Step 204 entails combining the PDE with the result from the Hertz model. By combining the results from the Hertz model and the partial differential equation, the overall model is built.

In one aspect, the TCTSC is configured to measure forces in a distinct way compared to prior approaches. Rather than enhancing sensitivity on a small volume or area, the TCTSC 100 leverages this cumulative, distributed effects to determine the tension exerted on the thread. Accordingly, the TCTSC provides a robust accurate approach that can be implemented in complex environments.

### Materials and Methods

### 11. Material and Methods

In some embodiments of the two-filament configuration of TCTSC 100, the negative filament 2 can be a commercial polytetrafluoroethylene (PTFE) coated silver plated copper wire. PTFE is a dielectric material with a high negative triboelectric series. The positive filament 3 can be either a commercial silver/polyester fiber blended filament for the PTFE-Silver configuration, or a commercial polyvinyl chloride (PVC) coated steel wire for the PTFE-PVC configuration.

In some embodiments of the three-filament configuration of TCTSC, the negative filament 2 can also be a commercial polytetrafluoroethylene (PTFE) coated silver plated copper wire. The positive filament 3 can be a silver/polyester fiber blended filament, and the core filament 8 can be a commercial nylon filament. This configuration is denoted as PTFE-0.4 Nylon-Silver or PTFE-1.0 Nylon-Silver, where the core nylon has a diameter of 0.4 mm or 1.0 mm, respectively.

For any of the TCTSC 100 configurations described herein, the twisted TCTSC 100 can be coated with a polyurethane layer for isolation and packaging, providing a stable shape and consistent force-output characteristics.

### III. Mass Production of TCTSC

To mass-produce TCTSC, the high-speed filament braiding machine is deployed to ensure consistent and stable manufacturing, as depicted in FIG. 3. When the filament twisting machine operates, the base disk 9 rotates, enabling the negative filament 2 and the positive filament 3 to be woven in the same direction around the core filament 8 for the three-filament configuration. Whereas for the two-filament configuration, the base disk 9 rotates to make a negative filament woven on a positive filament. The whole TCTSC 100 then passes through a guide roller 10 and enters the TPU glue chamber 11, where it undergoes uniform insulation gluing (for example, polyurethane layer coating). Subsequently, the fiber proceeds to the heating chamber 12, where the TPU glue is solidified, ensuring its adhesion to the filament. Finally, the fiber is stably wound on the reel by the take-up device 13. By changing the speed ratio between the rotation of the base disk 9 and the take-up device 13, variable pitch of TCTSC can be achieved.

### IV. Key Performance Metrics

To assess performance, five key metrics have been defined: i) range, ii) linearity, iii) sensitivity; iv) hysteresis; and v) robustness.
i) Range: The maximum input force at which the TCTSC maintains linear output response. This maximum input force varies based on various factors, including, but not limited to: the materials of the core and/or filaments, the dimensions of the core and/or filaments, the number of filaments, and the winding pitch of the filaments. It is appreciated that variations of these factors could be used to design a TCTSC for a particular application in order to meet the force requirements of a particular application.
ii) Linearity: The linear correlation coefficient between output voltage and input force at the upper bound of the input range, is shown by the following equation:

$$Corr ( Input , Output ) = \frac{Cov ( Input , Output )}{stdev ( Input ) stdev ( Output )} \qquad ( 1 )$$

where Cov(Input, Output) is the covariance between Input and Output. stdev(Input) and stdev(Output) are the standard deviations of Input and Output.
iii) Sensitivity: Because the TCTSC has length-proportional output, the sensitivity is normalized by its length. Hence, the sensitivity is defined as the maximum output within the linear range, divided by the corresponding maximum input force and current length, as shown by the following equation:

$$Sensitivity = \frac{Output Range}{Range \times Length} \qquad ( 2 )$$

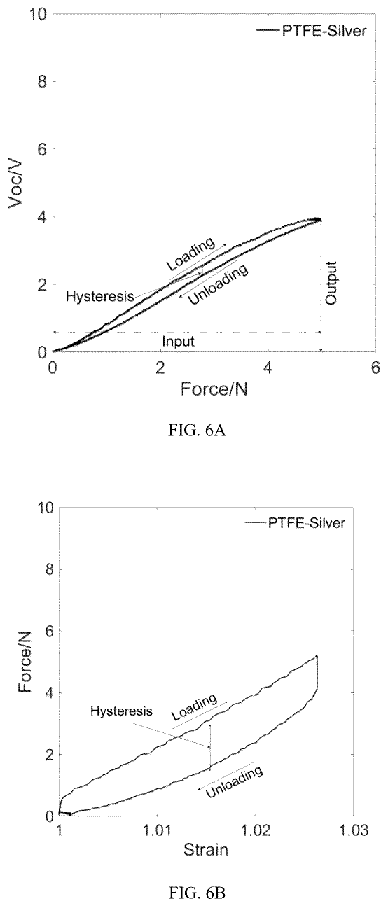

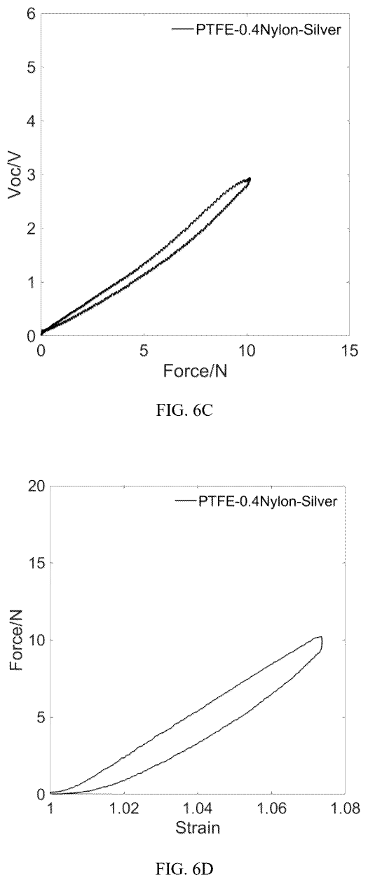

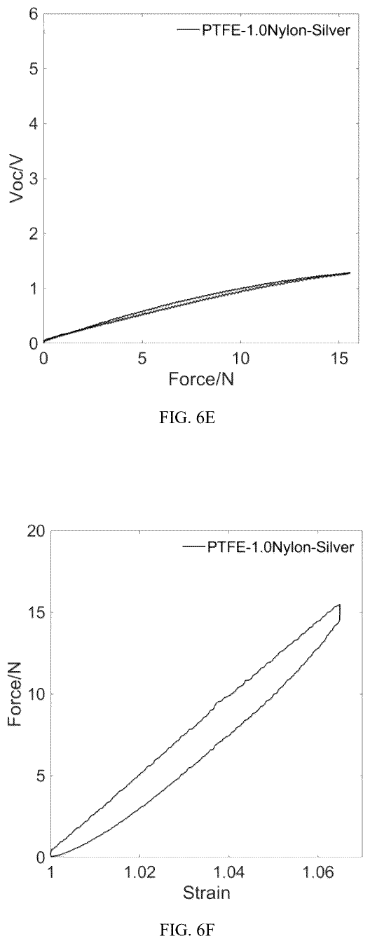

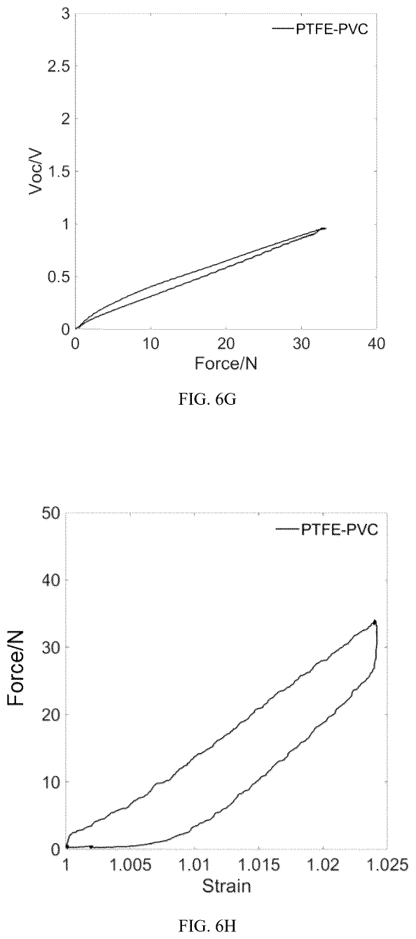

iv) Hysteresis: Hysteresis is defined as the maximum difference in output voltage at the same input force, when tensioned to maximum linear range then unloaded, divided by the maximum output voltage as shown in FIGS. 6A-6H. This definition is same as the previous definition.

$$Hysteresis = \frac{Max ( {Output}_{loading} ( Input ) - {Output}_{unloading} ( Input ) )}{Range} \qquad ( 3 )$$

When used in a radar graph, the hysteresis is changed to 1-hysteresis to enable TCTSC with lower hysteresis or better performance to have higher values.
v) Robustness: The ratio of maximum linear output per unit length to the radial response per unit length, as shown by the following equations

$$Radial sensivity = \frac{Radial response}{Radial press force \times Press length} \qquad ( 4 )$$

$$Robustness = \frac{Sensivity}{Radial sensivity} \qquad ( 5 )$$

where the Radial response, Radial press force and Press length are shown in FIGS. 6A-6E.

These five metrics can be used to form radar plots, directly assessing the performance of the different TCTSC configurations, as described in further detail below.

### V. Characterization

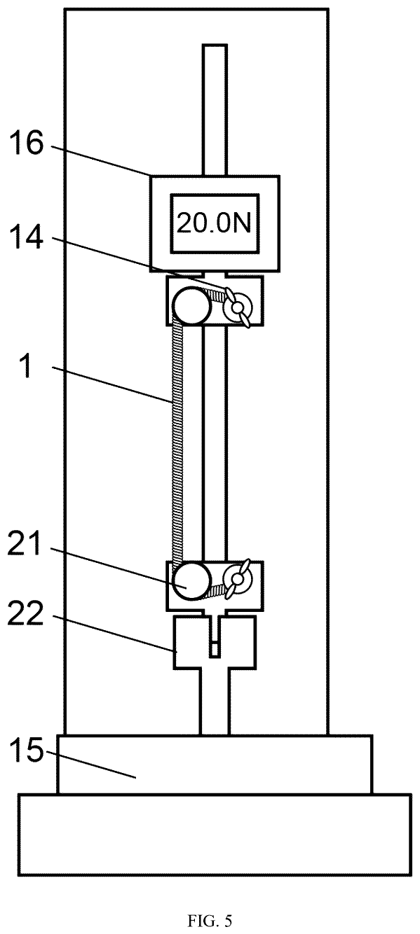

To investigate the output characteristics, metrics, and hysteresis of the TCTSC, the following experimental setup is adopted, as shown in FIG. 5. Unless indicated otherwise, subsequent references to TSCTSC 100 in the specification and figures can refer to either the two-fiber configuration or the three-fiber configuration. To minimize the effects of radial pressure, filament-specific fixtures are used. The TCTSC 100 is loaded on tensile testing machine 15. Specifically, the TCTSC 100 is fixed by a rotary knob 14 and through a guide roller 21, then secured on the load cell 16 and fixture 22 of the tensile testing machine 15. In the experimental setup, the TCTSC 100 was directly connected to a Keithley 6514 electrometer to acquire its output signal. A Keithley 6514 electrometer with high input impedance can restore signals with high fidelity. Considering the testing range of the tensile testing machine, the length of TCTSC should be much larger than the length pressed by the knob 14 to minimize the interference from press. In this experiment, the test length was selected as 500 mm. The upper fixture drives the TCTSC to be tensioned within the linear region, increasing the force in 1 N steps until significant nonlinearity appeared. The TCTSC was then untensioned at a constant speed of 5 mm/min, and this process was repeated 5 times. Simultaneously, the encoder in the tensile testing machine 15 measured the strain of the TCTSC 100. This experimental setup allowed for the simultaneous testing of the range, linearity, sensitivity, and hysteresis of the TCTSC 100.

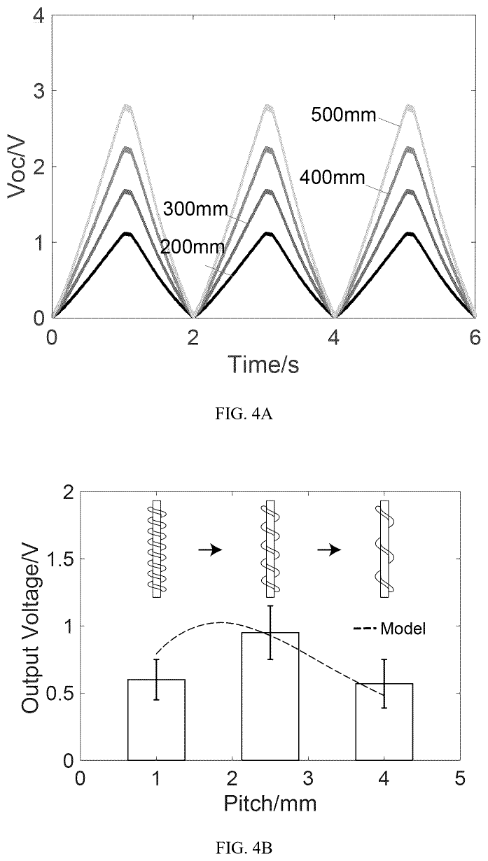

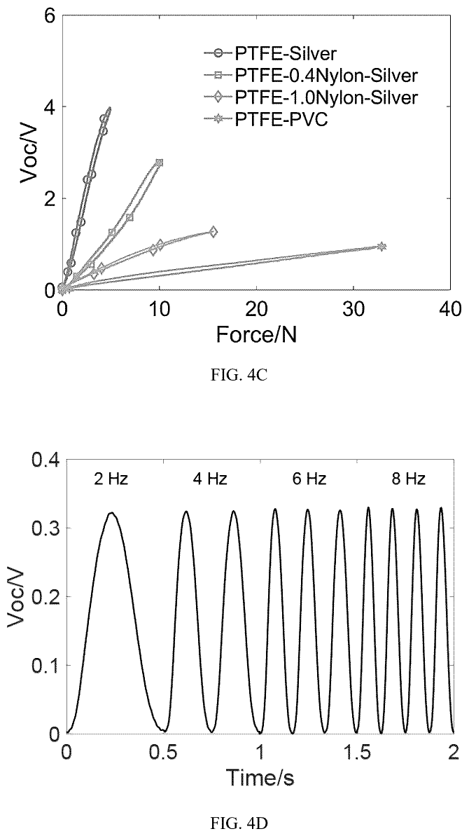

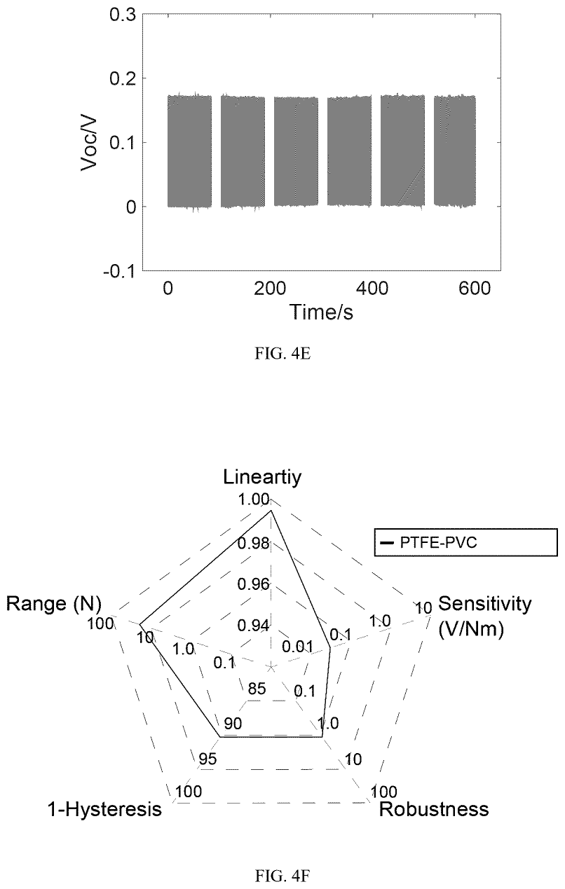

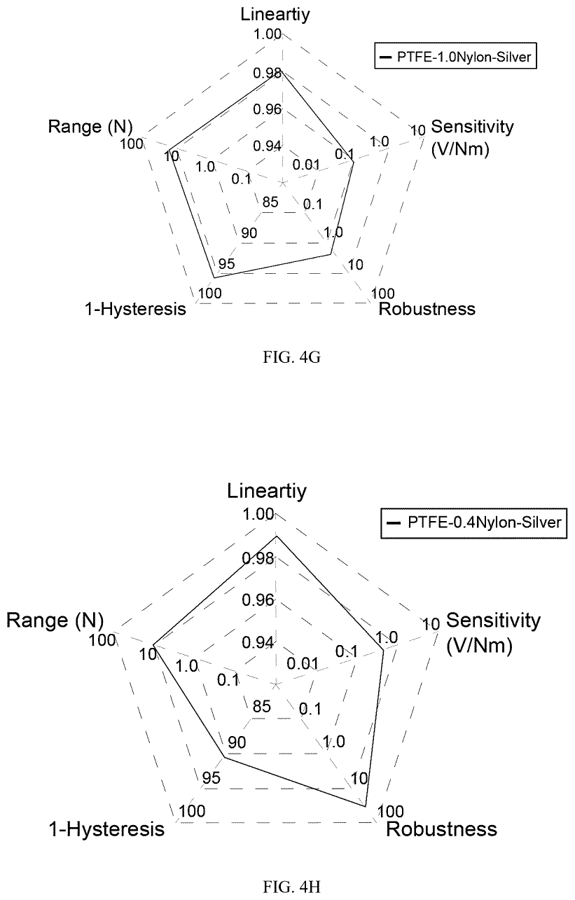

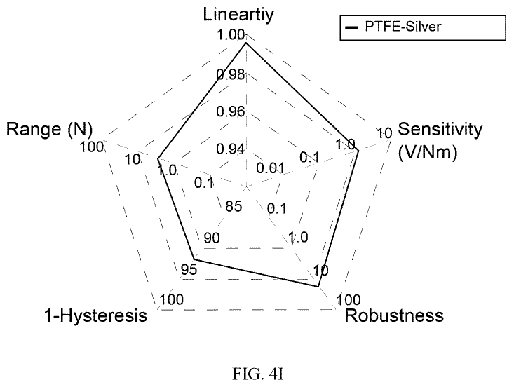

First, the relationship between output voltage and TCTSC 100 sample length was experimentally investigated. As depicted in FIG. 4A the TCTSC 100 shows a quasi-linear relationship between input tension and output voltage the model in Model Section demonstrates the quasi-linear nature of this structure. As shown in FIG. 4A, the output voltage exhibits a linear increase as the TCTSC length is increased from 100 mm to 500 mm under constant tension. This indicates that the output signal or sensitivity has a proportional relationship with TCTSC length, demonstrating the cumulative effects. The model explains the principle of this linear length relationship, as it utilizes the integration of surface charge density to obtain the even potential difference per unit length of the cross-section.

Because the TCTSC comprises a helical filament wound around a core, the helix pitch strongly affects the sensitivity. As shown in FIG. 4B, when the pitch increases from 1 mm to 2 mm, the sensitivity increases. However, the sensitivity then continues to decrease as the pitch is increased further. Samples with three pitches are built with PTFE-0.4 Nylon-Silver configuration, and the results match this modeled trend. Increasing the pitch further causes lower sensitivity, because as the pitch increases, the length of the TCTSC decreases faster than the contraction of the core diameter of the helix. Ultimately, all four configurations were chosen with a 2.5 mm pitch, as this offered a good balance of higher sensitivity and manufacturing efficiency.

Moreover, 500 mm samples with above-mentioned four configurations were tested, and the results are shown in FIG. 4C. All configurations exhibit high linearity, with the PTFE-Silver configuration achieving up to 0.9982, and low hysteresis, with the PTFE-1.0 Nylon-Silver configuration reaching as low as 4.6%. The configurations also exhibit varying range and sensitivity, with the PTFE-PVC configuration achieving up to 34 N range and the PTFE-Silver configuration achieving up to 1.59 V/Nm sensitivity, as detailed in the radar graph in FIGS. 4F-4I. Increasing the core filament's clastic modulus increases the range but decreases sensitivity, as can be seen from the gradient and range of the horizontal axis. Notably, the hysteresis is lower than the core filament's, regardless of whether the configuration is two-filament or three-filament, as shown in FIGS. 6A-6H. This phenomenon reveals that the hysteresis metric is independent of the core property, enabling the flexible combination of materials for diverse scenarios. The model derived that the output is derived from the contact between the helix and core filaments, independent of the core filament's strain.

### A. Hysteresis Loop

The core filament mainly determines the force-strain relationships of the TCTSC. However, if the voltage output is directly related to the strain of the TCTSC, the overall force voltage relationship will inherit the large hysteresis of the force-strain relationships. Using the same characterization setup as shown in FIG. 5, the hysteresis is investigated. As tested in FIG. 6A, the hysteresis between force-strain of the PTFE-silver configuration is as large as 30%.

However, the hysteresis between force-voltage was as low as 5%. The results in FIG. 6A-6H all show that regardless of the TCTSC configuration, the hysteresis between force and voltage is consistently lower than the hysteresis between force and strain. This suggests that the hysteresis does not relate to the strain, but instead seems to be directly related to the force. The model explains the phenomenon that the TCTSC's output is directly related to the force on the helix. Hence, the hysteresis is attributed to the contact between the helix and the core filament, rather than the overall strain of the TCTSC.

### B. Frequency Response and Lifetime Test

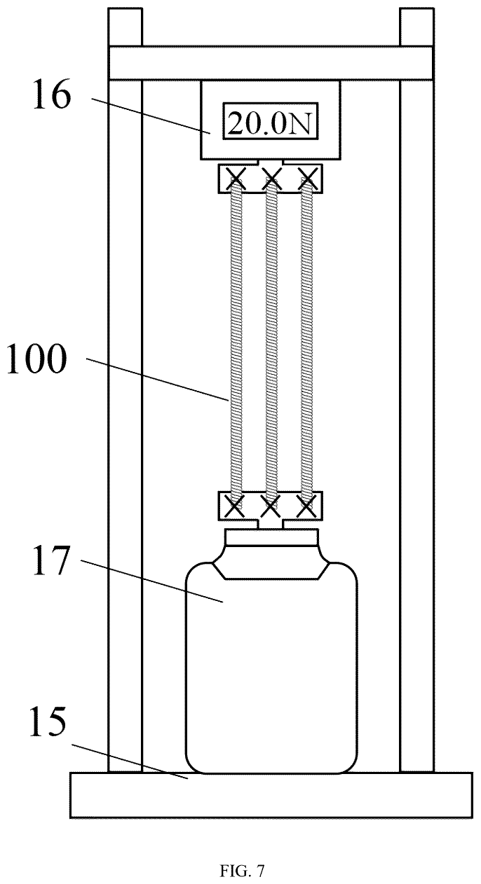

In order to test the frequency response and lifetime characteristics, the TCTSC is fixed on a frame in a three-fold configuration, as shown in FIG. 7. One end of the fixture 15 is connected to a load cell 16, while the other end is connected to a vibration generator 17 (for example, ET-126B-04, Labworks Inc.). The same electrometer is used to acquire the TCTSC's output signals. The vibration generator's frequency was switched from 2 Hz to 8 Hz to investigate the frequency response of the TCTSC. Additionally, the TCTSC's lifetime was also tested on this setup at a fixed frequency of 8 Hz.

The frequency response of the TCTSC was also tested, as shown in FIG. 4D. The output range remained constant as the frequency of the vibration exciter increased up to 8 Hz, demonstrating the TCTSC's suitability for deployment in most force measurement scenarios. As shown in FIG. 4E, the lifetime test for the TCTSC, which was conducted using the configuration detailed above, demonstrates no output decay even after over 6,000 cycles, highlighting the stability of the configuration.

### C. Robustness Test

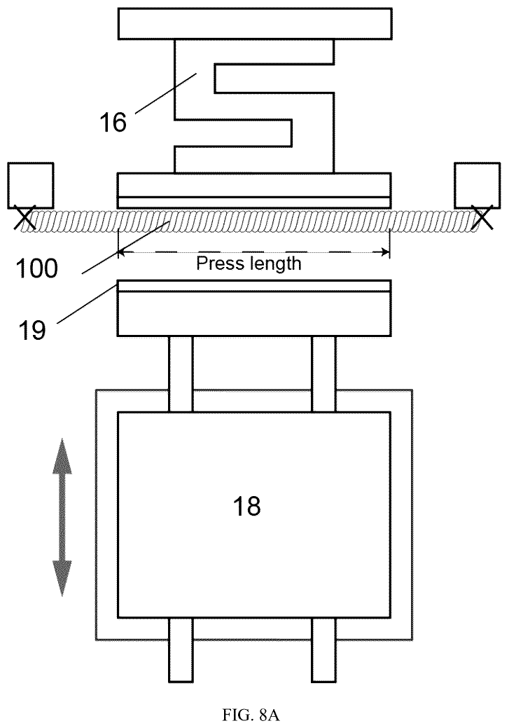

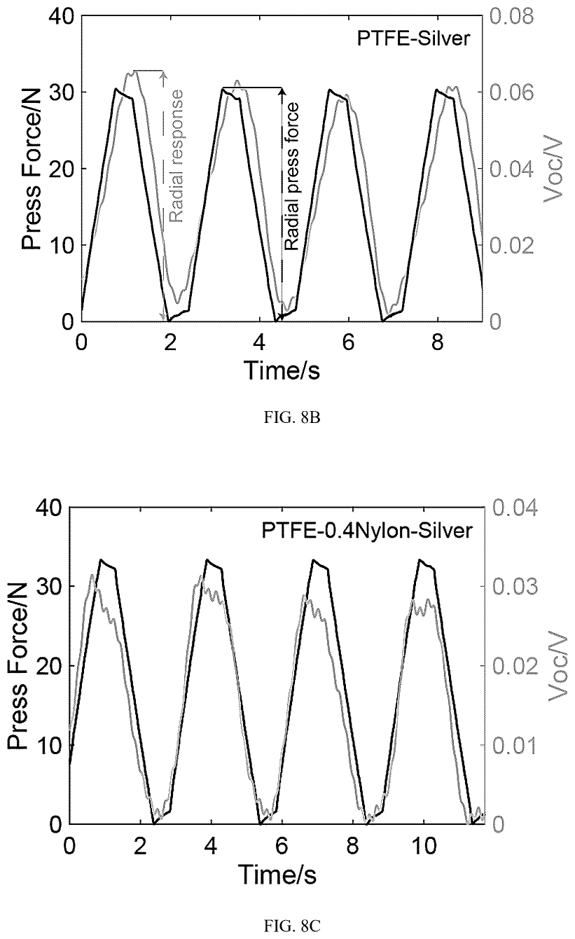

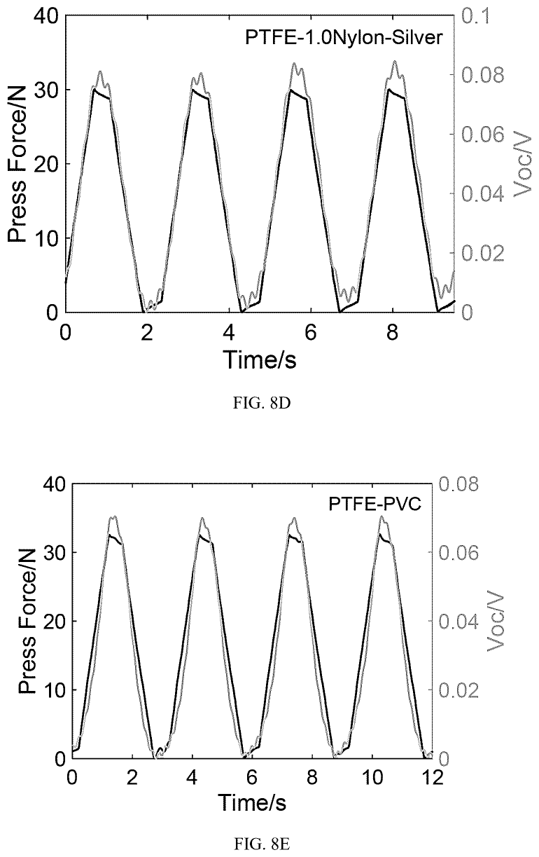

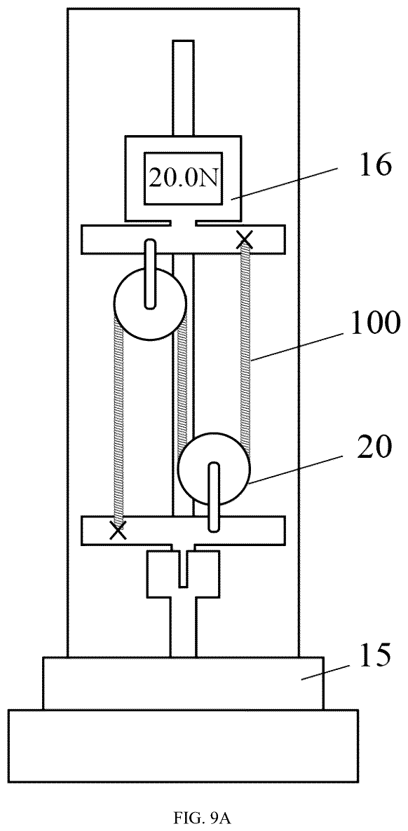

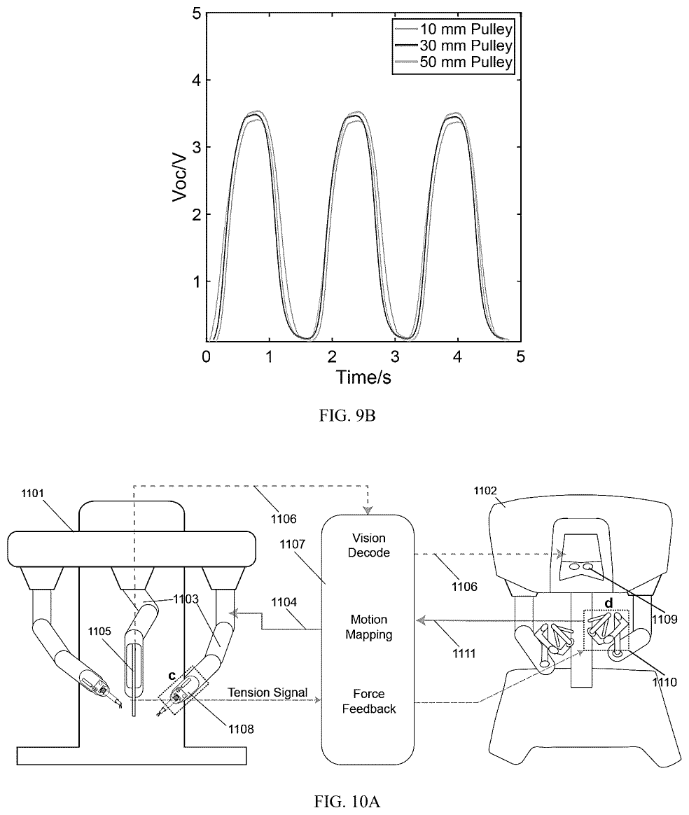

Because the TCTSC leverages this cumulative, distributed effects to determine the tension exerted on the thread, the radial pressing affects the output. To obtain the robustness metric defined in the Key Performance Metrics section, the four configurations were pressed radially by a linear motor, as shown in FIG. 8A, and all showed a linear relationship between the radial pressing force and output voltage, as demonstrated in FIGS. 8B-8E. The results showed that for the PTFE-0.4 Nylon-Silver configuration, although the pressing force reaches up to 30 N, the output is only 0.028 V per 60 mm, which is low compared to the axial output per force as shown in FIG. 4C. This configuration exhibits the highest robustness, reaching up to 44.2045 as shown in FIGS. 4F-4I. The result also shows a trend that the stiffer the core filament (the higher the elastic modulus), the lower the robustness metric achieved. This is because the axial sensitivity is largely affected by the elastic modulus of the core filament, while the radial sensitivity is not. In practical applications, cables can be guided through pulleys, as in cable-driven parallel robots or exoskeletons. To show the effects of the metrics of robustness, the impact of pulleys on the sensor output is investigated. The same tension range was applied to the same TCTSC with PTFE-0.4 Nylon-Silver configuration through different pulleys, as illustrated in FIG. 8A. FIG. 8A shows the setup using a linear motor 18 with a glass head 19 to impact the TCTSC, which is fixed on another glass with a force sensor 16 to acquire the force during the impact. The results show less than a 3% difference, suggesting that pulleys have a minimal effect on the sensor output. This indicates the TCTSC's robustness to lateral compression, as the special structure of the TCTSC and guided length only accounts for a small part of the total length.

### VI. Applications

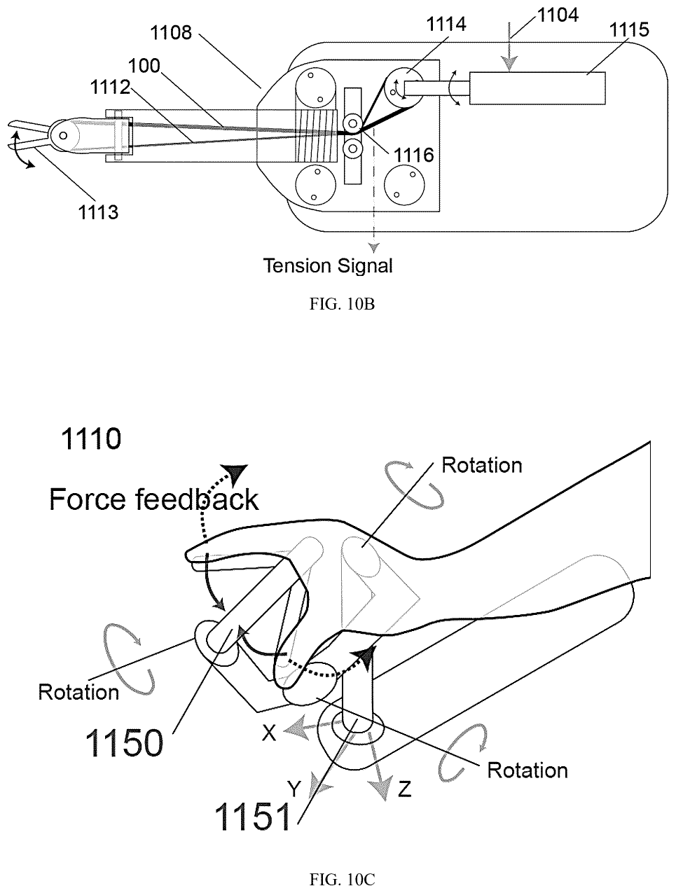

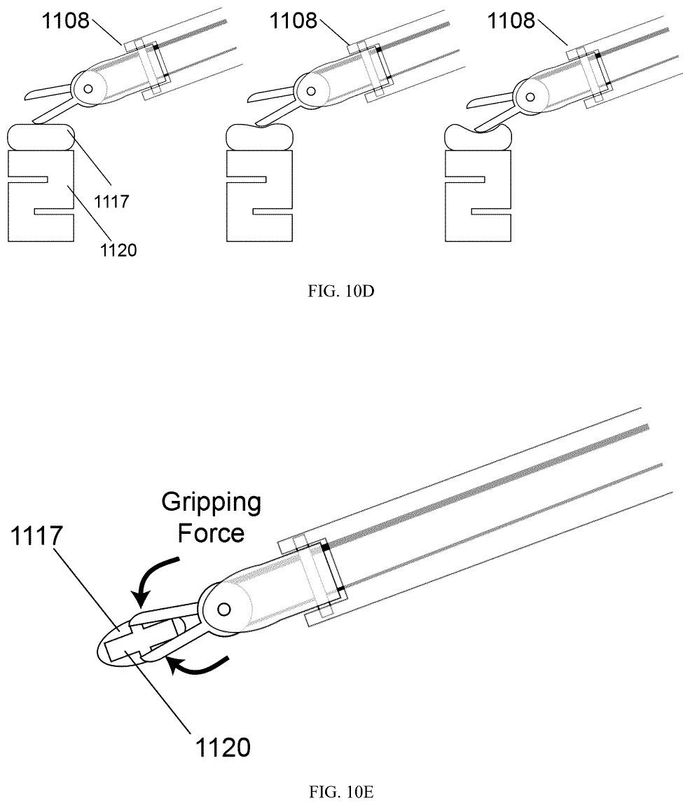

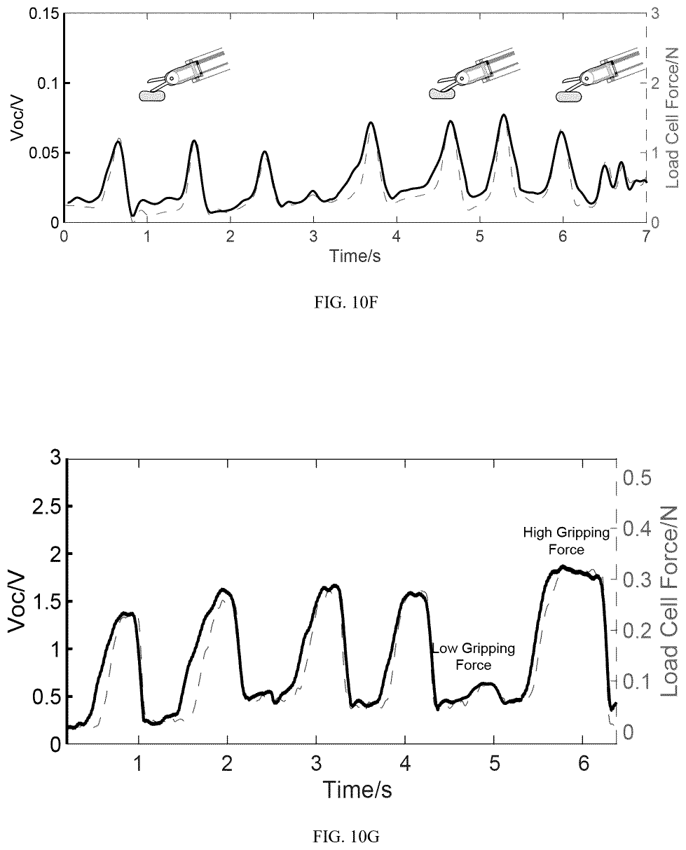

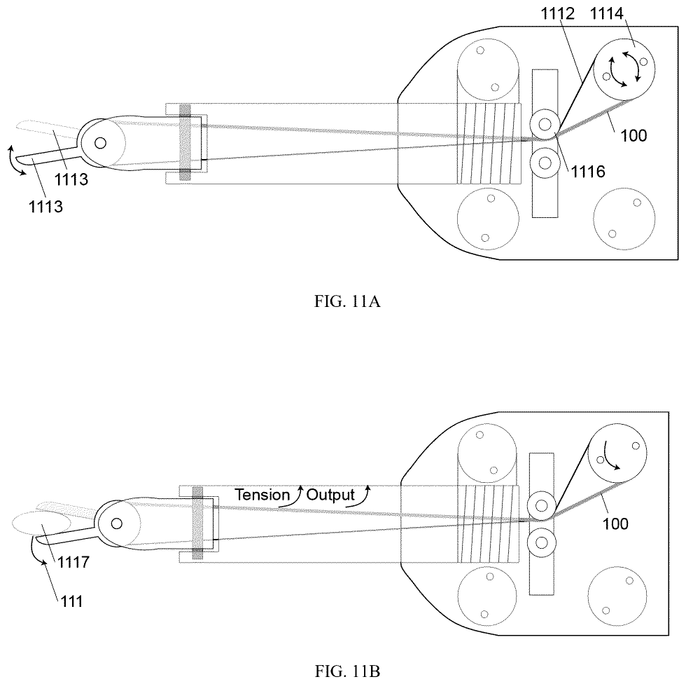

Robot-assisted endoscopic surgery of MIS techniques has emerged as a valuable tool in modem medical interventions. For example, a surgical robot with a master-slave structure represented by da Vinci surgical system, where the end effector is cable driven mechanism as shown in FIG. 10A. It offers benefits such as faster recovery times, reduced postoperative pain, and shorter hospital stays. Despite these advantages, it only has visual feedback (as shown in FIGS. 10A-10B) and remains limited due to the loss of direct tactile feedback. Surgeons performing these procedures often lack the sense of touch, especially grasping force feedback, a crucial perceiving for improving accuracy. This leads to the risk of unintentionally applying excessive forces that could cause tissue damage. To address this limitation, reintegrating haptic capabilities into robot-assisted surgical systems is necessary with various sensors on the gripper. The conventional strain gauge approach may affect output performance and is specifically designed for an instrument. Fragile measurements like Fiber Bragg gratings also face challenges in complex interactive settings. Hence, a self-proprioceptive method, the use of TCTSC on da Vinci forceps, as shown in FIGS. 10C-10E and FIGS. 11A-C, is a viable solution that can provide the benefits detailed above.

A conventional surgical system is formed with master-slave structure and the end effector is cable-driven. As shown in the example of FIG. 10, such systems generally include two main parts: the patient-side robot 1101 and the surgeon-side robot 1102. The patient-side robot 1101 has multi-DOF robotic arms 1103 that get the motion signal 1104 to control the posture and the position of the camera 1105, which feeds the video signal 1106 to the control unit 1107. It also controls the position and part of the posture of the cable-driven EndoWrist 1108, which is the main executive part of the system with different instrument types. The surgeon-side robot 1102 includes goggles 1109 that display the video feed 1106 from the patient-side 1101, and an operator interface 1110 to send motion commands 1111 to the control unit 1107. The operator interface 1110 comprises a six-DOF base 1151 with a triangular tool 1150 setup to simulate the moving actions and closing of the forceps 1113 of the EndoWrist tools 1108, as shown in FIG. 10D.

The EndoWrist part 1108, shown in FIG. 10C, is a cable-driven mechanism. Two cables 1112 are fixed at the end of the gripper 1113 and then wrapped around a cable spool 1114 through a pulley 1116 controlled by the motor 1115 at the end of the multi-DOF robot arm 1103. Upon receiving motion signal 1104, the motor 1115 rotates the spool 1114, pulling the cables 1112 around the gripper 1113, thus controlling the opening and closing movement of the gripper 1113 according to the motion signal received. The tension on the cable 1112 can reflect any force disturbance on the gripper 1113, compensating for the lack of force feedback with the appropriate force generator on the triangle tool 1150, as shown in FIG. 10D. As shown in FIG. 10C and FIGS. 11A-11C, the original steel cables 1112 have been replaced with TCTSC 100. Due to the small diameter of the pulleys 1116 relative to the overall length of TCTSC 100, its force output is hardly disturbed. Therefore, TCTSC 100 can restore the force from the end gripper 1113 of the forceps. When the forceps grip a tissue 1117, the reaction force 111 of the tissue 1117 causes the tension on the TCTSC 100 to increase, hence the output increases as shown in FIG. 11B. When the gripper contacts the tissue, the reaction force causes a different direction force on the gripper, reducing the tension on TCTSC and the output decreases, as shown in FIG. 11C.

As shown in FIG. 10E, the forceps press down on the ‘soft tissue’, simulating collisions encountered during surgery. A load cell 1120 is placed below the soft tissue 1117 to measure the pressing force. The pressing force increases as the forceps indent into the tissue 1117 deeper. The random pressing shows that the output of TCTSC is close to the pressing force measured by the load cell 1120, as shown in FIG. 10F, and the error comes from the system's friction hysteresis, as well as the load cell 1120 measuring only one direction of force. The forceps are then used to grasp the ‘soft tissue’ 1117 with a load cell 1120 embedded into it, as shown in FIG. 10G. The forceps grasp the ‘soft tissue’ 1117 with various forces, and the comparison between the grasping force and the TCTSC output, as shown in FIG. 10G, demonstrates the potential in endowing force sensing in cable-driven systems.

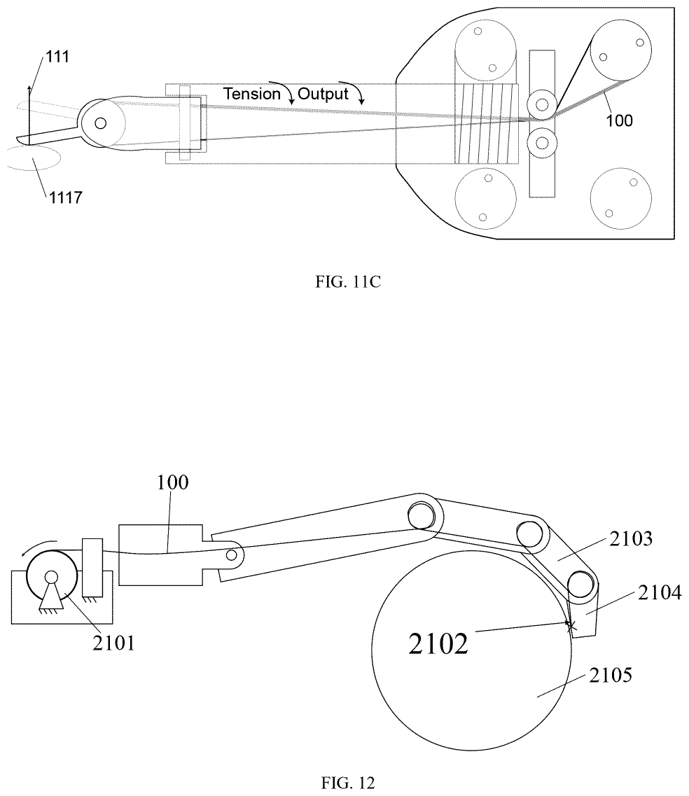

FIG. 12 shows an embodiment where the TCTSC 100 is applied in cable-driven prosthetic hand, the same as the principle in a surgical robot, where the motor 2101 drives TCTSC 100, which drives the finger 2103. When the fingertip 2104 touches the object 2105, the tension on TCTSC 100 increases, hence the TCTSC can detect the touching force 2102.

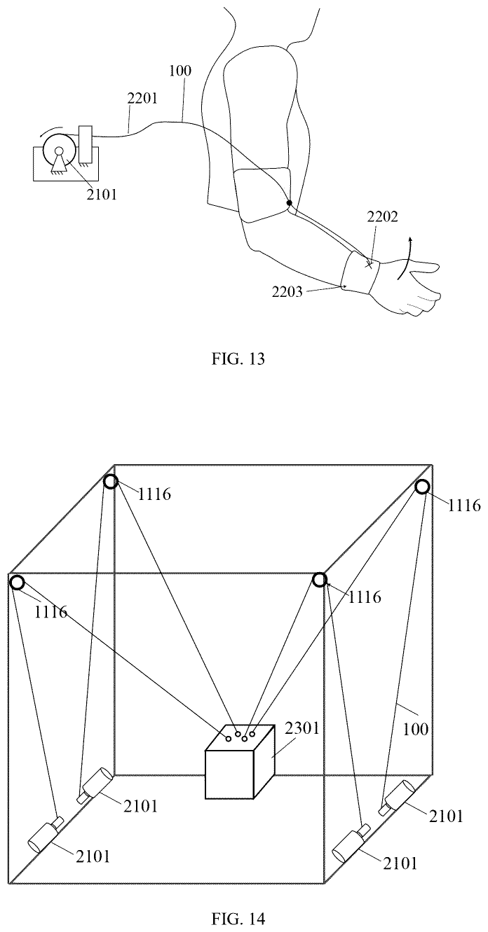

FIG. 13 shows an embodiment where the TCTSC 100 is applied in cable driven exosuit. When the motor 2101 pulls the TCTSC 100 and drives the anchor point 2202 on the sleeve 2203 through sheath 2201, the tension goes up and the elbow flexes, hence the TCTSC 100 can detect the interaction force between the cable and the elbow.

FIG. 14 shows an embodiment where the TCTSC 100 is applied in a parallel robot. As shown, several motors 2101 drive the object 2301 by the TCTSC 100 across pulley 1116, hence the TCTSC 100 can detect the interaction force between the object 2301 and the cables help provide accurate force control.

The description set forth above in connection with the appended drawings is intended as a description of various embodiments of the disclosed subject matter and is not necessarily intended to represent the only embodiment(s). In certain instances, the description includes specific details for the purpose of providing an understanding of the disclosed embodiment(s). However, it will be apparent to those skilled in the art that the disclosed embodiment(s) can be practiced without those specific details. In some instances, well-known structures and components can be shown in block diagram form in order to avoid obscuring the concepts of the disclosed subject matter. In the drawings, like reference numerals represent like parts throughout the several views.

In the preceding specification, the invention is described with reference to specific embodiments thereof, but those skilled in the art will recognize that the invention is not limited thereto. Various features, embodiments and aspects of the above-described invention can be used individually or jointly. Further, the invention can be utilized in any number of environments and applications beyond those described herein without departing from the broader spirit and scope of the specification. The specification and drawings are, accordingly, to be regarded as illustrative rather than restrictive. It is recognized that the terms “comprising,” “including,” and “having,” as used herein, are specifically intended to be read as open-ended terms of art. Further, the term “about” is interpreted to mean+/−10% of the respective value.

### EXEMPLARY EMBODIMENTS

Embodiments of the subject invention include, but are not limited to, the following exemplified embodiments:

Embodiment 1. A tension sensing cable for cable driven mechanisms that responds to axial tensile force applied onto the cable, where the radial pressure applied onto the cable has a lower effect on a voltage output of the cable compared to an axial force, the cable comprising:
a primary filament, wherein the primary filament is conductive and has an outer contact surface;
a secondary filament, wherein the secondary filament is conductive and has an outer contact surface, and wherein one or both of the first and secondary filaments are wound in a helical fashion;
wherein the cable is configured such that:
when the primary and secondary filaments contact with each other, charges transfer between the primary filament and secondary filament on both contact surfaces, and
when an axial tensile force is applied to the cable, a potential difference generated by the transferred charges between the primary and secondary filaments changes, wherein the change corresponds to the applied axial tensile force.

Embodiment 2. The tension sensing cable of embodiment 1, wherein when the cable is bent, the bending has a lower effect on the output as compared to the axial tensile force.

Embodiment 3. The tension sensing cable of any preceding embodiment, wherein the secondary filament includes a dielectric layer disposed thereon.

Embodiment 4. The tension sensing cable of any preceding embodiment, wherein the primary filament has a dielectric layer disposed thereon, where the primary and secondary filaments have different triboelectric series, thereby causing charges transferred between primary filament and secondary filament on both contacted surfaces.

Embodiment 5. The tension sensing cable of embodiment 4, wherein the secondary filament has a dielectric layer disposed thereon.

Embodiment 6. The tension sensing cable of any preceding embodiment, wherein the primary filament is wound around the secondary filament in helical fashion with the secondary filament being a core filament.

Embodiment 7. The tension sensing cable of any preceding embodiment, wherein the primary and secondary filaments are wound in a helical fashion around another dielectric core filament.

Embodiment 8. The tension sensing cable of any preceding embodiment, wherein an overall strain of the cable when axial tensile force is exerted on the cable is within 10%.

Embodiment 9. The tension sensing cable of any preceding embodiment, wherein the change of the voltage output as the tensile axial force is exerted on the cable is quasi-linear.

Embodiment 10. The tension sensing cable of any preceding embodiment, wherein a pitch of the helically wound primary and/or secondary filament corresponds to a desired sensitivity.

Embodiment 11. The tension sensing cable of any preceding embodiment, wherein the cable includes a core filament around which the primary and/or secondary filaments are wound, and wherein an elastic modulus of the core filament corresponds to a desired testing range and/or sensitivity of the cable.

Embodiment 12. A method of fabricating a tension sensing cable for cable driven mechanisms that responds to axial tensile force applied onto the cable, the method comprising:
providing a primary filament, wherein the primary filament is conductive and has an outer contact surface; and
winding a secondary filament along the primary filament in a helical fashion with the primary filament as a core filament, wherein the secondary filament is conductive and has an outer contact surface, wherein the secondary filament is wound such that when the primary and secondary filaments contact with each other, charges transfer between the primary filament and secondary filament on both contact surfaces, and when an axial tensile force is applied to the cable, a potential difference generated by the transferred charges between the primary and secondary filaments changes, wherein the change corresponds to the applied axial tensile force.

Embodiment 13. The method of embodiment 12, further comprising applying a dielectric layer on one or both of the primary and secondary filament.

Embodiment 14. The method of any preceding embodiment, further comprising winding the secondary filament at a pitch selected to correspond to a desired sensitivity.

Embodiment 15. The method of any preceding embodiment, further comprising selecting the core filament to have an elastic modulus that corresponds to a desired testing range and/or sensitivity of the cable.

Embodiment 16. A method of fabricating a tension sensing cable for cable driven mechanisms that responds to axial tensile force applied onto the cable, the method comprising:
providing a core filament that is dielectric;
providing a primary filament and secondary filament, wherein the primary and secondary filaments are conductive and each has an outer contact surface;
winding the primary and secondary filament along the core filament in a helical fashion in a same direction, wherein the primary and secondary filaments are wound such that when the primary and secondary filaments contact with each other, charges transfer between the primary filament and secondary filament on both contact surfaces, and when an axial tensile force is applied to the cable, a potential difference generated by the transferred charges between the primary and secondary filaments changes, and wherein the change corresponds to the applied axial tensile force.

Embodiment 17. The method of embodiment 16, further comprising applying a dielectric layer on each of the primary and secondary filaments.

Embodiment 18. The method of any preceding embodiment, further comprising winding the primary and secondary filaments at a pitch selected to correspond to a desired sensitivity.

Embodiment 19. The method of any preceding embodiment, further comprising selecting the core filament to have an elastic modulus that corresponds to a desired testing range and/or sensitivity of the cable.

Embodiment 20. The method of any preceding embodiment, further comprising applying a dielectric coating on the assembled cable.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

We claim:

1. A tension sensing cable for cable driven mechanisms that responds to axial tensile force applied onto the cable, where the radial pressure applied onto the cable has a lower effect on a voltage output of the cable compared to an axial force, the cable comprising:
a primary filament, wherein the primary filament is conductive and has an outer contact surface;
a secondary filament, wherein the secondary filament is conductive and has an outer contact surface, and wherein one or both of the first and secondary filaments are wound in a helical fashion;
wherein the cable is configured such that:
when the primary and secondary filaments contact with each other, charges transfer between the primary filament and secondary filament on both contact surfaces, and
when an axial tensile force is applied to the cable, a potential difference generated by the transferred charges between the primary and secondary filaments changes, wherein the change corresponds to the applied axial tensile force.

2. The tension sensing cable of claim 1, wherein when the cable is bent, the bending has a lower effect on the output as compared to the axial tensile force.

3. The tension sensing cable of claim 1, wherein the secondary filament includes a dielectric layer disposed thereon.

4. The tension sensing cable of claim 1, wherein the primary filament has a dielectric layer disposed thereon, where the primary and secondary filaments have different triboelectric series, thereby causing charges transferred between primary filament and secondary filament on both contacted surfaces.

5. The tension sensing cable of claim 4, wherein the secondary filament has a dielectric layer disposed thereon.

6. The tension sensing cable of claim 1, wherein the primary filament is wound around the secondary filament in helical fashion with the secondary filament being a core filament.

7. The tension sensing cable of claim 1, wherein the primary and secondary filaments are wound in a helical fashion around another dielectric core filament.

8. The tension sensing cable of claim 1, wherein an overall strain of the cable when axial tensile force is exerted on the cable is within 10%.

9. The tension sensing cable of claim 1, wherein the change of the voltage output as the tensile axial force is exerted on the cable is quasi-linear.

10. The tension sensing cable of claim 1, wherein a pitch of the helically wound primary and/or secondary filament corresponds to a desired sensitivity.

11. The tension sensing cable of claim 1, wherein the cable includes a core filament around which the primary and/or secondary filaments are wound, and wherein an elastic modulus of the core filament corresponds to a desired testing range and/or sensitivity of the cable.

12. A method of fabricating a tension sensing cable for cable driven mechanisms that responds to axial tensile force applied onto the cable, the method comprising:
providing a primary filament, wherein the primary filament is conductive and has an outer contact surface; and
winding a secondary filament along the primary filament in a helical fashion with the primary filament as a core filament, wherein the secondary filament is conductive and has an outer contact surface, wherein the secondary filament is wound such that when the primary and secondary filaments contact with each other, charges transfer between the primary filament and secondary filament on both contact surfaces, and when an axial tensile force is applied to the cable, a potential difference generated by the transferred charges between the primary and secondary filaments changes, wherein the change corresponds to the applied axial tensile force.

13. The method of claim 12, further comprising applying a dielectric layer on one or both of the primary and secondary filament.

14. The method of claim 12, further comprising winding the secondary filament at a pitch selected to correspond to a desired sensitivity.

15. The method of claim 12, further comprising selecting the core filament to have an elastic modulus that corresponds to a desired testing range and/or sensitivity of the cable.

16. A method of fabricating a tension sensing cable for cable driven mechanisms that responds to axial tensile force applied onto the cable, the method comprising:
providing a core filament that is dielectric;
providing a primary filament and secondary filament, wherein the primary and secondary filaments are conductive and each has an outer contact surface;
winding the primary and secondary filament along the core filament in a helical fashion in a same direction, wherein the primary and secondary filaments are wound such that when the primary and secondary filaments contact with each other, charges transfer between the primary filament and secondary filament on both contact surfaces, and when an axial tensile force is applied to the cable, a potential difference generated by the transferred charges between the primary and secondary filaments changes, and wherein the change corresponds to the applied axial tensile force.

17. The method of claim 16, further comprising applying a dielectric layer on each of the primary and secondary filaments.

18. The method of claim 16, further comprising winding the primary and secondary filaments at a pitch selected to correspond to a desired sensitivity.

19. The method of claim 16, further comprising selecting the core filament to have an elastic modulus that corresponds to a desired testing range and/or sensitivity of the cable.

20. The method of claim 16, further comprising applying a dielectric coating on the assembled cable.
